(19) United States
(12) Patent Application Publication
(10) Pub. No.: US 2006/0249333 A1
(43) Pub. Date: Nov. 9, 2006

(54) Elevator system

(75) Inventor: Warren Bruce Watt, Kareela (AU)

Correspondence Address: SUGHRUE MION, PLLC, 2100 PENNSYLVANIA AVENUE, N.W., SUITE 800, WASHINGTON, DC, 20037, US

(73) Assignee: Eastern Elevators Pty. Limited

(21) Appl. No.: 10/548,598

(22) PCT Filed: Mar. 12, 2004
(86) PCT No.: PCT/AU04/00301

§ 371 Date: May 31, 2006

(30) Foreign Application Priority Data
Mar. 12, 2003 (AU) 2003100189

(51) Int. Cl. B66B 1/00

(52) U.S. Cl. 187/277

(57) ABSTRACT

An elevator system (20) including: an elevator car assembly (2); and a cable (7) interconnecting the assembly (2) with a counterweight (8), wherein the cable (7) is coupled to the assembly (2) at a lower region (23) thereof.

### FIELD

This invention relates to an elevator system, particularly for use with a cantilevered elevator car.

### BACKGROUND

A known form of elevator system 1, as shown in FIG. 1, is disclosed in European Patent No. 1216949. The system 1 includes a cantilevered elevator car assembly 2 which is driven up and down an elevator shaft 3 by a motor 4 which is positioned at a top end 5 of the shaft 3. The motor 4 has a drive sheave 6 which engages and drives a rope or cable 7, which passes over the sheave 6 and interconnects a counterweight 8 at one end 9 and a top cross-beam 10 of a frame 11 of the car assembly 2 at the other end 12. Such a system 1 provides a space saving advantage in that positioning of the motor 4 at a top end of the elevator shaft 3 dispenses with the need for a separate motor room at a base of the shaft 3.

Object

The present invention seeks to provide an improved elevator system.

### SUMMARY OF THE INVENTION

In accordance with the invention, there is provided an elevator system including:
an elevator car assembly; and
a cable interconnecting the assembly with a counterweight,
wherein the elevator car assembly is cantilevered and the cable is coupled to the assembly at a lower region thereof.

Preferably, the cable is connected to a lower structural beam of the assembly.

Preferably, the system includes a motor for driving the cable, wherein the motor is positioned so as to be laterally adjacent the car assembly, when the lower region of the assembly is adjacent a top terminal landing serviced by the system.

Preferably, the motor is arranged in a position lower than a roof of the assembly when a floor of the elevator car assembly is level with the top terminal landing.

In another aspect, there is provided a method for supporting and driving a cantilevered elevator car assembly including connecting an end of a drive cable to a lower region of the assembly.

### BRIEF DESCRIPTION OF THE DRAWINGS

The invention is described in more detail with reference to the accompanying drawings, in which:

FIG. 1 is a diagrammatic side view of a known elevator system; and

FIG. 2 is a diagrammatic side view, illustrating the present invention.

### DETAILED DESCRIPTION

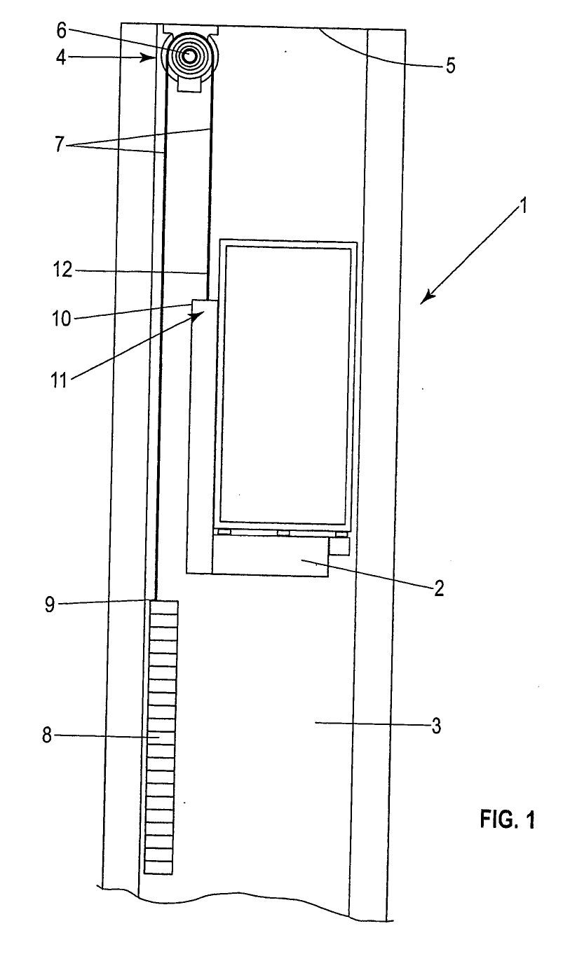

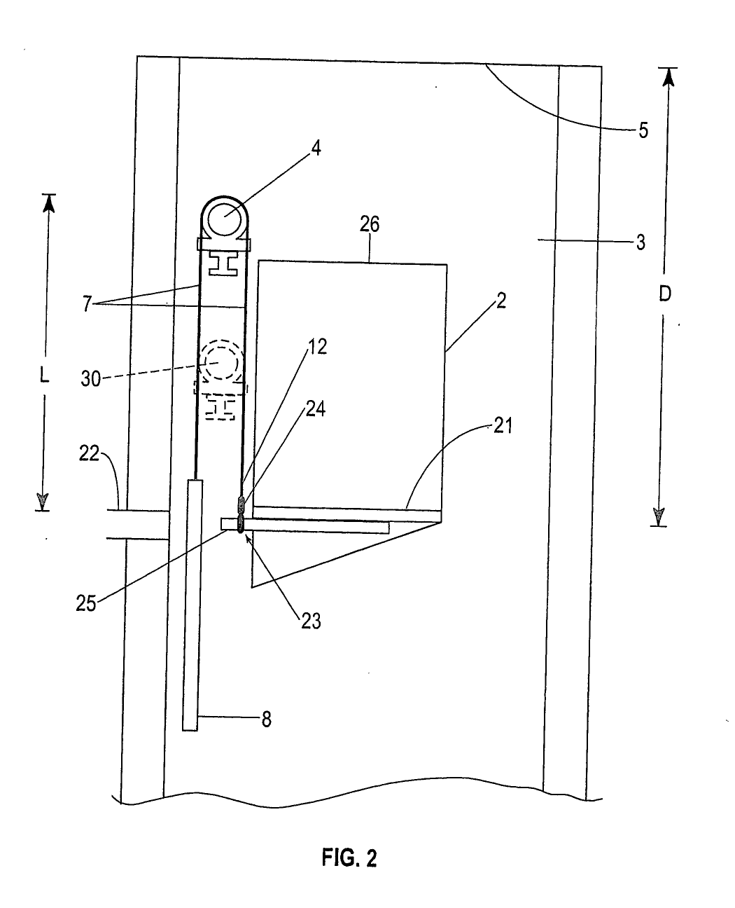

An elevator system 20 is now described with reference to FIG. 2. The system 20 has features similar to those shown in FIG. 1 and like reference numerals are used to denote like parts.

Similarly to system 1, the elevator system 20 includes a cantilevered elevator car assembly 2 coupled to a counterweight 8 via a rope or cable 7, which is driven by a motor 4, to allow the car assembly 2 to travel up and down elevator shaft 3. The cable 7 is, however, coupled to the elevator car assembly 2 at a lower region 23 of the assembly 2, as compared to the top cross-beam 10 shown in FIG. 1. More particularly, the cable 7 is connected to sockets 24 which are in turn coupled to a lower structural beam 25 of the assembly 2 so as to provide a length of cable ‘L’ between the motor 2 and the sockets 24.

A further difference between the systems 1 and 20 is that the motor 4 is supported in spaced relation to the top end 5 of the shaft 3. The motor 4 can, in fact, be positioned further away from the end 5 of the shaft 3 such as in the location shown in dashed outline 30, where the motor 4 is below a roof 26 of the assembly 2 and laterally adjacent the assembly when level with a top floor 22 serviced by the system 20.

In relation to the positioning of the motor 4 relative to the car assembly 2, a certain minimum distance needs to be maintained between the motor 4 and the end 12 of the cable connected to the car assembly 2, to accommodate overrun of the car assembly and the like. The specific length of cable required to accommodate the overrun is calculated by taking into consideration a number of factors such as a counterweight buffer stroke, which is the displacement distance of a buffer at a base of the elevator shaft, which is used to arrest downward displacement of the counterweight. Since the cable 7 is connected to the car assembly 2 at the lower region 23, the relevant overrun can be readily accommodated within the length ‘L’ of cable 7. The motor 4 may be placed at a substantially lower location as a result, as compared to the location of the motor 4 of FIG. 1, where the placement of the motor needs to be above the car assembly 2 itself.

The arrangement of the system 20 may thereby provide a number of advantages. Flexibility exists in the specific placement of the motor 4 and the motor 4 may be more readily accessed by a person standing on the roof 26. Also, the overall height requirements for the shaft 3 may be reduced which could perhaps result in some economic advantage in the form of space and construction savings, such as by allowing the top end 5 of the shaft 3 to be lowered, or in the form of allowing an additional floor to be added and serviced by the system 20, whilst still complying with initial building height restrictions.

To further illustrate the potential height advantage provided by the system 20, a standard minimum lift shaft overrun calculation was made for comparison with the system 1. The minimum lift shaft overrun may be taken as a distance ‘D’ between the top floor 22 served and the top end 5 of the shaft 3. The calculations were conducted for a system intended to carry 13 passengers at 1.0 m/s with: a counterweight buffer stroke of 80 mm; a counterweight buffer clearance of 450 mm, below the motor or its support; and a top-of-car person clearance of 1570 mm, which is a clearance required for a maintenance person standing on top of the car assembly 2. The minimum lift shaft overrun for the system shown in FIG. 1 was found to be 4680 mm while that required for system 20 was only 3960 mm, which indicates a clear height advantage may be realised utilising the present invention.

The invention has been described by way of non-limiting example only and many modifications and variations may be made thereto without departing from the spirit and scope of the invention described.

What is claimed is:

1. An elevator system including:
an elevator car assembly for travel within an elevator shaft;
a cable interconnecting the assembly with a counterweight; and
a motor for driving the cable,
wherein the elevator car assembly is cantilevered and the cable is coupled to the assembly at a lower region thereof; and
the motor is positioned in spaced relation to a roof of the elevator shaft, so as to be laterally adjacent to the car assembly when the assembly is at a top terminal landing serviced by the system.

2. An elevator system as claimed in claim 1, wherein the cable is connected to a lower structural beam of the assembly.

3. An elevator system as claimed in claim 1, wherein the motor is arranged in a position lower than a roof of the assembly when a floor of the elevator car assembly is level with the top terminal landing.

4. An elevator system as claimed in claim 3 wherein the motor is arranged in a position laterally adjacent a central region of the assembly when the floor of the elevator car assembly is level with the top terminal landing.

5. An elevator system as claimed in claim 1, wherein the motor is able to be reached by a person standing on the roof of the elevator car assembly when the roof of the elevator car assembly is level with the top terminal landing.

6. An elevator system as claimed in claim 1, wherein the elevator car assembly travels within the elevator shaft at speeds in the order of 1 m/s.

7. An elevator system as claimed in claim 1, wherein the elevator car assembly travels within the elevator shaft on guide rails and the motor is positioned at a location below upper ends of the guide rails.

8. An elevator system as claimed in claim 1, wherein the elevator car assembly travels within the elevator shaft on guide rails and the motor is mounted between the guide rails at a location spaced from upper ends of the guide rails.

9. An elevator system as claimed in claim 7, wherein the motor is mounted on a beam connected between the guide rails.

10. An elevator system as claimed in claim 7, wherein the elevator car assembly is arranged to couple to the guide rails to avoid obstruction as the car assembly travels along the guide rails and past the motor.

11. An elevator system as claimed in claim 10, wherein the elevator car assembly is coupled to outwardly facing surfaces of the guide rails.

12. An elevator system including an elevator car assembly, for travel within an elevator shaft, guide rails to which the car assembly is coupled, and a motor mounted at a location below upper ends of the guide rails, wherein the elevator car assembly is arranged to couple to the guide rails, so as to avoid obstruction from the motor as the car assembly travels along the guide rails and past the motor.

13. An elevator system as claimed in claim 12, wherein the elevator car assembly is coupled to outwardly facing surfaces of the guide rails.
